(19) United States
(12) Patent Application Publication
(10) Pub. No.: US 2008/0315639 A1
(43) Pub. Date: Dec. 25, 2008

(54) Foam Seat with Sensor

(76) Inventors: Susanne Wenmackers, Langenfeld (DE); Hans Erber, Odenthal (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/908,011

(22) PCT Filed: Mar. 10, 2006
(86) PCT No.: PCT/EP06/60638

§ 371 Date: Nov. 2, 2007

(30) Foreign Application Priority Data
Mar. 11, 2005 (DE) 10 2005 011 742.2

(51) Int. Cl. B60N 2/44; B29C 33/00

(52) U.S. Cl. 297/217.3; 297/452.48; 425/117

(57) ABSTRACT

The invention relates to a foam part for a vehicle, in particular for a seat cushion, wherein the foam part comprises a first partial area and a second partial area, which are connected together in one piece along a connecting area. The first partial area comprises a first surface and the second partial area comprises a second surface which are oriented towards each other. The first partial area is formed as a flap of the second partial area, with the connecting area forming a so-called living hinge. A sensor device can be inserted between the first and second partial areas for sensing the presence of a seated vehicle occupant.

The present invention relates to a foam part for a vehicle, in particular for a seat and, in particular, with a sensor means, a method for producing a foam part with a sensor means, the use of a foam part according to the invention as a seat part for a vehicle, in particular for a motor vehicle, as well as a tool for producing the foam part according to the invention.

In seats for vehicles, in particular for motor vehicles, seat occupancy sensors are frequently provided, for example in order to control the activation of airbags. In order to be able to detect the seat occupancy substantially over the entire surface, seat occupancy sensors are provided as surface sensors, for example in the form of mats. The seat occupancy sensors are, for example, arranged between a foam part of a seat part of a seat and the cover. So that perfect functioning and optimal comfort is ensured, and in order not to have a negative effect on the appearance of such a seat, covers for such seats must have a laminate thickness of at least approximately 7 mm. The required laminate thickness for seats without seat occupancy sensors is, however, only approximately 2-4 mm. Thus conventionally, either different covers are used which is costly relative to the arrangement. Otherwise, only covers with a greater laminate thickness are used which is, above all, costly, therefore, as only a very small percentage of less than 10% of the seat is equipped with seat occupancy sensors.

The publication DE 196 46 480 A1 discloses a method for producing a seat which provides for producing the seat cushion from two parts which are made separately from one another, between which the seat occupancy sensor is arranged. For the separate production of the two seat parts, said seat parts and the seat occupancy sensor have to be subsequently assembled and connected together. The method is, therefore, very costly.

It is the object of the invention to provide a foam part with a sensor means, in particular a seat part with a seat occupancy sensor, and a method for producing the foam part which does not have the aforementioned drawbacks, and therefore may be produced cost-effectively as well as which allows the use of cost-effective covers.

The object is achieved by a foam part for a vehicle, in particular for a seat, the foam part comprising a first partial area and a second partial area which are connected together in one piece along a connecting area, the first partial area comprising a first surface and the second partial area comprising a second surface which face one another.

A foam part according to the invention may be produced very easily, for example, by being cut from a foam part or by being foamed. The production of the two partial areas may be carried out, in terms of tool engineering, at the same time as the forming of the foam part or subsequently by separating the first partial area from the second partial area in the area of the first and second surface, the partial areas still remaining connected together in one connecting area. The production of the two partial areas at the same time as the forming of the foam part has the advantage that the production step of the subsequent separation of the partial areas from one another is dispensed with.

Preferably, the first surface is arranged substantially parallel to the second surface, at least respectively locally, so that even with a curved first surface the distance of the second surface from the first surface is substantially the same everywhere. As a result, the separation of the two partial areas from one another is possible by performing a cut with a cutting tool. The subsequent separation of the partial areas from one another has the advantage that it is also possible with conventional foam parts.

Further preferably, the connecting area extends substantially in one longitudinal direction. In this embodiment, the separation of the first partial area from the second partial area is possible in a manner which is very simple, rapid and cost-effective, for example by means of cutting wire, in particular a hot wire.

In a preferred embodiment of the foam part, which also achieves the object, the foam part comprises a first partial area and a second partial area, which are connected together in one piece along a connecting area, the first partial area being able to be folded relative to the second partial area along the connecting area. As a result, the area between the partial areas during production, for example, of a vehicle seat is freely accessible, for inserting, for example, a seat occupancy sensor, namely by simply folding (up) the first partial area relative to the second partial area.

The following embodiments apply to both solutions of the object.

In a connecting area extending in one longitudinal direction, the connecting area acts as a rotational axis, when folding the two partial areas relative to one another preferably along the longitudinal axis thereof.

In a preferred embodiment, the foam part comprises a sensor means which is arranged between the first partial area and the second partial area. The sensor means is thus laminated and protected by the partial areas.

With a curved connecting area, in which the area between the partial areas has, for example, the shape of a pocket, the sensor means is inserted into the pocket. With partial areas which may be folded relative to one another, the area between the partial areas is freely accessible, so that the sensor means may be placed onto the first or the second surface. The arrangement of the sensor means between the partial areas is, therefore, particularly simple in this embodiment.

Preferably, the sensor means substantially bears against at least one of the two surfaces, particularly preferably against both surfaces. Preferably, the first and/or the second surface substantially form one plane. A sensor means, in particular a surface sensor, for example a seat occupancy sensor, is preferably arranged on the plane in a two-dimensional manner. The foam part is preferably made from an elastic material, in particular from a plastics material. Due to the elasticity of the foam part, said foam part adapts to the contours of the sensor means.

When using the foam part with sensor means as a seat part for a vehicle, the partial areas may be selected such that the sensor means is not noticeable and that, therefore, the seating comfort for a user of the seat is not impaired. The visual impression of such a seat is also not negatively affected by the sensor means.

Preferably, the first partial area extends substantially two-dimensionally and has a thickness which is particularly preferably approximately 4-12 mm, quite particularly preferably approximately 5-10 mm. The thickness of the foam part may be adapted according to the requirements which are set for the foam part.

When using the foam part, for example as a seat part of a seat, the thickness of the first partial area may be adapted to the desired thickness of the cover, in particular to the desired laminate thickness of the cover, as the first partial area compensates for the laminate thickness of the cover of conventional seats required for the sensor means, in particular for a seat occupancy sensor, with a seat occupancy sensor arranged on the seat part. As a result, the first partial area ensures the operating reliability of the seat occupancy sensor and ensures at the same time that the seat comfort as well as the visual impression of the seat is not negatively affected. The cover of such a seat part according to the invention may, therefore, have a considerably reduced laminate thickness than is the case with conventional seats with a cover arranged directly over the seat occupancy sensor.

Preferably, the foam part comprises a recess in which electrical wiring of the sensor means is arranged so that the comfort and the visual impression of the seat is also not negatively affected by the electrical wiring.

The foam part according to the invention may be produced easily and cost-effectively. As the sensor means is arranged between the partial areas, it is thereby protected. The use of the foam part as a seat part of a vehicle allows the adaptation of the thickness of the first partial area to the desired laminate thickness of the cover, so that the same cover may be used for the variant with and without sensor means, without additional costs arising.

A further subject of the present invention is a method for producing a foam part with a sensor means, preferably a surface sensor, a first partial area being separated from a second partial area, so that the partial areas remain connected together in one piece along a connecting area and the sensor means being then arranged between the partial areas.

Particularly preferably, the arrangement of the sensor means in the foam part is carried out with a connecting area extending substantially in one longitudinal direction by folding the first partial area relative to the second partial area about the connecting area, so that the connecting area acts as a rotational axis in the longitudinal direction thereof, so that the bearing surface for a fitter is freely accessible and the insertion of the sensor means is therefore very simple. Subsequently, the first partial area is folded back about the connecting area in the opposing direction. Preferably the first partial area then bears at least partially against the second partial area, so that the sensor means is completely enclosed by the partial areas.

The separation of the first partial area and the second partial area is preferably carried out by a cut with a hot wire.

A further subject of the present invention is a method for producing a foam part with a sensor means, a first partial area as well as a second partial area which are connected together in one piece along a connecting area, the first partial area comprising a first surface and the second partial area comprising a second surface, which face one another, the foam part being foamed in one piece, and the sensor means being then arranged between the partial areas.

The foam part may, therefore, be produced in one piece with its two partial areas, so that the production is particularly cost-effective.

The following embodiments apply to both methods for producing the foam part with the sensor means.

Preferably, the sensor means is connected to electrical wiring which is arranged in a recess of the foam part. As the wiring is arranged in a recess of the foam part, the visual impression of the seat is not negatively affected by the wiring.

Further preferably, the foam part is covered by a cover. As a result, the first and the second partial area are fixed relative to one another. In both production methods, therefore, the same foam part may be used for both variants, with and without sensor means.

The person skilled in the art understands that, additionally to the cover, further padding may also be provided on the foam part, which is arranged thereon, in particular before covering the foam part with fabric. Further padding is, for example, a pad made of felt or horsehair or a seat heater.

As the partial areas are finally fixed to one another by the cover, they do not have to be fixed by additional connections such as for example sewing, bonding or clamping. As a foam part according to the invention is generally covered by a cover, for improving the visual impression, said solution is very rapid and cost effective. Optionally, according to the invention it is nevertheless possible to provide a fixing of the first partial area—in particular on its side remote from the connecting area—to the second partial area, namely by means of a Velcro connection.

A further subject of the present invention is the use of the foam part according to the invention as a seat part for a seat for a vehicle, in particular for a motor vehicle. The sensor means is protected by the first partial area. The adaptation of the thickness of the first partial area allows the use of a cover with a very thin laminate thickness. Moreover, the same foam part may be used for both variants, with and without sensor means, as with such a seat part the first partial area and the second partial area are fixed relative to one another by the cover, and/or the first partial area and the second partial area are separated from one another by a cut only in those seat parts which are equipped with a sensor means.

Preferably, the sensor means is a seat occupancy sensor. In this embodiment, the first partial area ensures the function of the seat occupancy sensor, by the first partial area ensuring the required distance between a person using the seat or an object arranged on the seat and the seat occupancy sensor.

A further subject of the present invention is a tool for producing a foam part according to the invention, the negative image of the shape of the first surface and/or the second surface being incorporated into the tool. The tool allows a very rapid and cost-effective production of a foam part according to the invention, preferably by foaming, the production step of the separation of the first and second partial area being dispensed with.

The invention is described hereinafter with reference to figures. The figures are merely by way of example and do not restrict the general inventive idea.

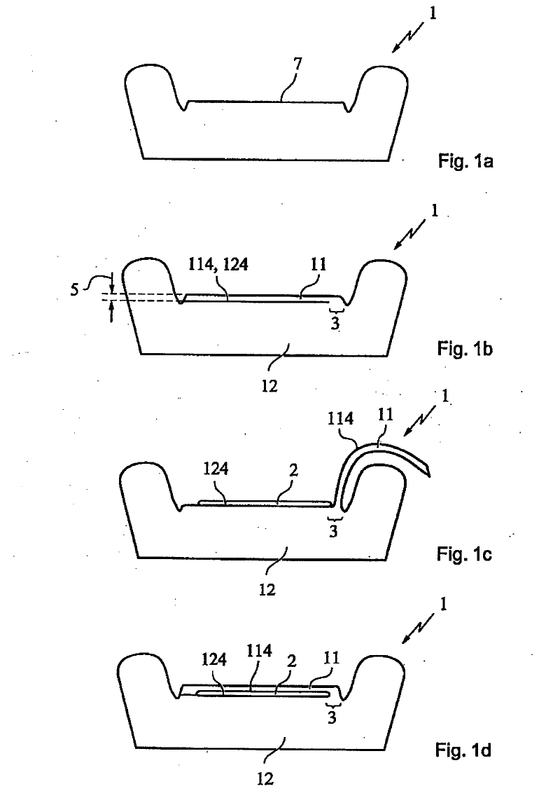

FIG. 1 shows in views a-d the method for producing a foam part according to the invention.

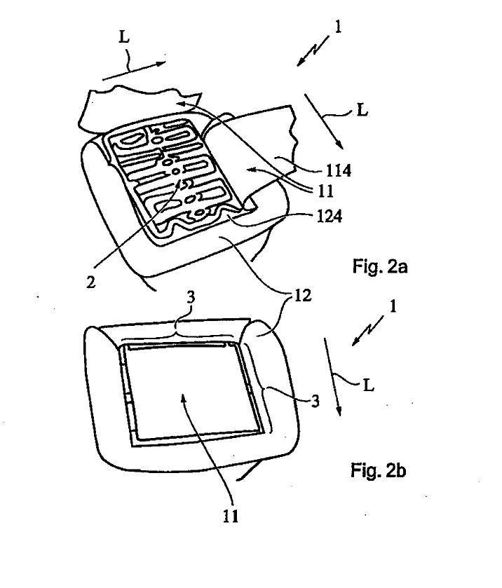

FIG. 2 shows in views a and b a foam part according to the invention during the assembly of a sensor means.

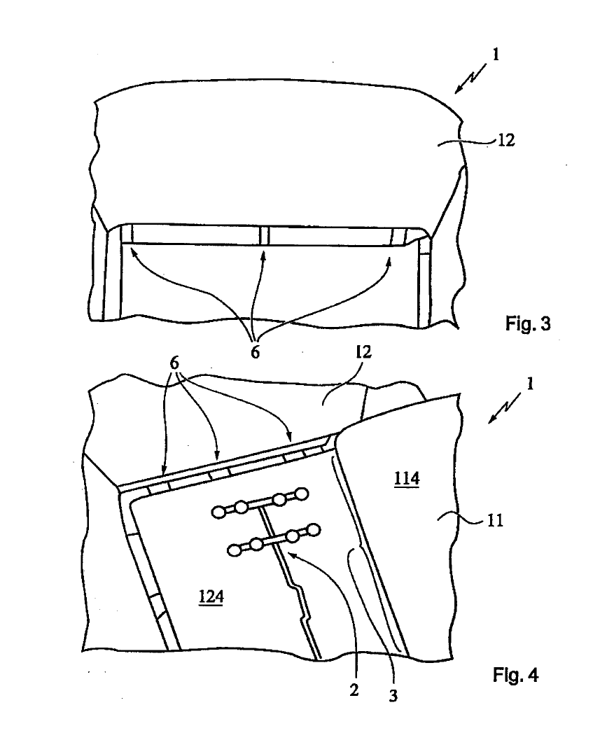

FIG. 3 shows a foam part according to the invention with recesses for the arrangement of wiring for a sensor means.

FIG. 4 shows a further embodiment of a foam part according to the invention with a sensor means.

FIG. 1 shows in views a-d, the method for producing a foam part 1 according to the invention. The foam part 1 is a seat part for a motor vehicle seat. Hereinafter, therefore, the terms foam part 1 and seat part are used synonymously. According to the requirements of the seat part 1, in particular depending on the planned laminate thickness of the cover, the seat part 1 is cut into, substantially parallel to the seat surface 7 thereof, see view b, so that a first partial area 11 and a second partial area 12 are produced, which remain connected together in one piece along a connecting area 3. The thickness 5 of the first partial area 11 is indicated by means of dotted lines and two arrows. The first partial area 11 comprises a first surface 114 and the second partial area 12 a second surface 124 which in this production step substantially bear against one another. Then the first partial area 11 is folded relative to the second partial area 12 about the connecting area 3, so that the connecting area 3 acts in the longitudinal direction L thereof (see FIG. 2), see view c. Subsequently, the sensor means 2 may be arranged between the partial areas 11, 12. Finally, the first partial area 11 is folded back in the opposing direction about the connecting area 3, so that the first partial area 11 preferably bears at least partially against the second partial area 12 and the sensor means 2 is fully enclosed by the first partial area 11 and the second partial area 12, see view d.

During production of the foam part 1 with a tool according to the invention, the first partial area 11 and the second partial area 12 are already formed together in terms of tool engineering so that the foam part 1 in the production step of view b is present. The insertion of the sensor means 2 is then carried out in a similar manner to the steps of views c and d.

In a foam part 1, not shown, with a pocket-shaped area between the partial areas 11, 12, the sensor means 2 is pushed between the partial areas 11, 12, without folding the partial areas 11, 12 relative to one another.

Due to the considerably simpler handling for the fitter, the foldable variant of the foam part 1 is preferred.

The sensor means 2 is connected, either after the arrangement on the second surface 124, see view c, or after completing the method, see view d, to electrical wiring, which is not shown in the figures. Moreover, the foam part 1 is covered by a cover which is also not shown in the figures, so that the first partial area 11 is fixed to the second partial area 12.

FIG. 2 shows in views a and b a foam part 1 according to the invention during the assembly of a sensor means 2. The foam part 1 comprises two first partial areas 11. The first partial areas 11 are respectively connected in one piece along respectively one connecting area 3 to the second partial area 12, the connecting areas 3 respectively extending substantially in one longitudinal direction L and being arranged substantially at right angles to one another. The first partial areas 11 are folded about the rotational axis formed by the connecting area 3, so that the area between the second partial area 12 and the two first partial areas 11 is freely accessible. In this freely accessible area a sensor means 2 is arranged, in this case a seat occupancy sensor. The seat occupancy sensor is a surface sensor which bears substantially against the plane formed by the second surface 124 of the second partial area 12. In view b the first partial areas 11 are respectively folded back about the connecting areas 3.

FIG. 3 shows a foam part 1 according to the invention with recesses 6 for arranging wiring for a sensor means 2. The side of the foam part 1 substantially remote from the first partial area 11, which is not shown here, and/or the second partial area 12 are visible. As the foam part 1 is a seat part for a seat, the wiring is guided onto the side of the seat which is not visible to the user in a conventional viewing direction, in the installed state of the seat, so that the visual impression of the seat is not impaired by the wiring. The wiring is not shown in the drawings.

FIG. 4 shows a further embodiment of a foam part 1 according to the invention with a sensor means 2. The sensor means 2 is, in this case, a seat belt occupancy detector. The foam part 1 comprises the first partial area 11 which is folded along the connecting area 3 relative to the second partial area 12, so that the second surface 124 is visible. As the sensor means 2 for the seat belt occupancy detector is not a surface sensor, the second surface 124 and/or the plane formed by the second surface 124 is substantially visible. In the edge area of the second surface 124 recesses 6 are visible which may be used for laying the electrical wiring of the sensor means 2.

When using a foam part 1 according to the invention as a seat part of a seat, the connecting area 3 may extend both in the direction of travel and also transversely to the direction of travel or at any angle relative to the direction of travel. The connecting area 3 may therefore be arranged, viewed in the direction of travel, to the front, rear, left, right or at any other angle thereto.

### LIST OF REFERENCE NUMERALS

1 Foam part, seat part for a seat
11 First partial area
114 First surface
12 Second partial area
124 Second surface
2 Sensor means
3 Connecting area
5 Thickness of the first partial area
6 Recess
L Longitudinal direction

1. A foam part (1) for a vehicle, in particular for a seat cushion, characterized in that the foam part (1) comprises a first partial area (11) and a second partial area (12) which are connected together in one piece along a connecting area (3), the first partial area (11) comprising a first surface (114) and the second partial area (12) comprising a second surface (124) which face one another.

2. The foam part (1) as claimed in claim 1, further characterized in that the first surface (114) is arranged substantially parallel to the second surface (124).

3. The foam part (1) as claimed in claim 1, further characterized in that the connecting area (3) extends substantially in one longitudinal direction (L).

4. The foam part (1) as claimed in claim 1, further characterized in that the connecting area (3) is resiliently flexible whereby the first partial area (11) may be folded relative to the second partial area (12) along the connecting area (3).

5. The foam part (1) as claimed in claim 1 further characterized in that it comprises a sensor means (2) which is arranged between the first partial area (11) and the second partial area (12).

6. The foam part (1) as claimed in claim 5, further characterized in that the sensor means (2) substantially bears against at least one of the two surfaces (114, 124).

7. The foam part (1) as claimed in claim 1 further characterized in that the first partial area (11) extends substantially two-dimensionally and has a thickness (5) in the range of 4-12 mm.

8. The foam part (1) as claimed in claim 5, further including a recess (6) in which electrical wiring of the sensor means (2) is arranged.

9. A method for producing a foam part (1) with a sensor means (2), preferably a surface sensor, characterized in that a first partial area (11) is separated from a second partial area (12), so that the partial areas (11, 12) remain connected together in one piece along a connecting area (3) and in that the sensor means (2) is then arranged between the partial areas (11, 12).

10. A method for producing a foam part (1) with a sensor means (2), a first partial area (11) as well as a second partial area (12) which are connected together in one piece along a connecting area (3), the first partial area (11) comprising a first surface (114) and the second partial area (12) comprising a second surface (124), which face one another, characterized in that the foam part is formed in one piece and that the sensor means (2) is then arranged between the partial areas (11, 12).

11. The method as claimed in claim 10, further characterized in that before or after the separation of the foam part (1) into the two partial areas (11, 12) the sensor means (2) is connected to electrical wiring which is arranged in a recess (6) of the foam part (1).

12. The method as claimed in claim 10, further characterized in that the foam part (1) is covered by a cover.

13. The use of a foam part as claimed in claim 1, wherein the foam part is a seat part for a seat for a vehicle, in particular for a motor vehicle.

14. The use as claimed in claim 13, further characterized in that the sensor means (2) is a seat occupancy sensor.

15. A tool for producing a foam part as claimed in claim 1, characterized in that the negative image of the shape of the first surface (114) and/or the second surface (124) is incorporated into the tool.
